(19) United States
(12) Patent Application Publication
(10) Pub. No.: US 2009/0116226 A1
(43) Pub. Date: May 7, 2009

(54) Carry-on light emitting decoration

(76) Inventor: Li-Chen Wang, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,648

(22) Filed: Nov. 7, 2007

(51) Int. Cl. F21V 21/084; F21V 21/08

(52) U.S. Cl. 362/105; 362/103

(57) ABSTRACT

The present invention relates to a carry-on light emitting decoration in which a light emitting device is provided on a base and an ornament section is correspondingly combined with the base. An appearance design matching with the event theme is formed on the ornament section. Further, a wearing member is abutted and combined with the base so as to be worn conveniently on a user's hand, head, and arm or fixed on the hat body. According to this structure, when the carry-on light emitting decoration is worn on the body of the user, the event theme is highlighted by the appearance design provided on the ornament section so as to raise the advertisement effect of event. Furthermore, the light emitting device emits light at night to construct the bustling atmosphere making effect of the activities.

### BACKGROUND OF THE INVENTION

1. Field of the Invention

The present invention relates to a carry-on light emitting decoration, particularly to a carry-on light emitting decoration on which an ornament section having a propaganda design is provided, which can emit light at night so as to construct the atmosphere of activities, and which is convenient to be worn on a user's body.

2. Brief Description of the Prior Art

Generally, in business promotion, literature and art presentations or sports contests, advertisement or propaganda objects are often used so as to achieve the promotion or the propaganda effect for a specific commodity, an individual or an organization. The advertisement or propaganda objects comprise advertisement signboards with lamps inside, advertisement billboards, advertisement curtains, advertisement and small or big propaganda flags.

Furthermore, in order to raise the activity momentum, clapping, whistling and air horn sounding are often used to make acoustic effect, or brandishing light sticks is also used so as to the enhance the entertainment effect and the pleasant atmosphere of the activity.

Accompanying with the diversification of business promotion, literature and art presentation or election campaign, auxiliary objects for activity propaganda also have to be innovated to possess not only practical functions but also strange and artistic design, with an intention to satisfy the increasingly high demand of consumers for commodity quality, and in the mean time to enhance the competitiveness of the commodity of the same category of products so as to take a certain part of the market. This is the key issue to which the concerned industries have to pay more attention. According to this idea, the inventor of this invention thus proposes a new propaganda object which not only can achieve the same propaganda features as the conventional propaganda object such as advertisement flag or fluorescent light stick and the light emitting effect at night, but also is handy to be worn with a user, such that a novel propaganda object having more propaganda effect can be prevailed on the market.

In view of the above fact, the inventor of this invention thus proposes a new propaganda object according to research and improvement made with respect to the existing structure after continuous devotion to the product development and design based on the experience and the knowledge accumulated in the long term involvement of relevant field.

### SUMMARY OF THE INVENTION

The main object of this invention is to provide a carry-on light emitting decoration which is handy to be worn with a user accompanying with the proceeding of propaganda activity, and which is provided with a ornament section matching with the event propaganda design, and which can emit light in night activity so as to enhance the bustling atmosphere making effect of the activity.

The carry-on light emitting decoration of the present invention has a light emitting device provided on a base and an ornament section is correspondingly combined with the base, an appearance design matching with the event theme is formed on the ornament section; further, a wearing member is abutted and combined with the base so as to be worn conveniently on user's hand, head, arm or fixed on the hat body. According to this structure, when the carry-on light emitting decoration is worn on the body of a user, the event theme is highlighted by the appearance design provided on the ornament section so as to further raise the advertisement effect of event. Additionally, emitting of light from the light emitting device at night activity further constructs the bustling atmosphere making effect of activity.

### BRIEF DESCRIPTION OF THE DRAWINGS

The present invention will be better understood by the detailed description of preferred embodiments with reference to the accompanied drawings, in which:

FIG. 1 is a perspective exploded view (I) of the carry-on light emitting decoration of the present invention.

FIG. 2 is a perspective view (I) of the carry-on light emitting decoration of the present invention.

FIG. 3 is a perspective exploded view (II) of the carry-on light emitting decoration of the present invention.

FIG. 4 is a perspective view (II) of the carry-on light emitting decoration of the present invention.

FIG. 5 is a perspective exploded view (III) of the carry-on light emitting decoration of the present invention.

FIG. 6 is a perspective view (III) of the carry-on light emitting decoration of the present invention.

FIG. 7 is a perspective exploded view (IV) of the carry-on light emitting decoration of a prior art.

FIG. 8 is a perspective view (IV) of the carry-on light emitting decoration of the present invention.

### DETAILED DESCRIPTION OF THE PREFERRED EMBODIMENTS

The technical content, objects and effectiveness of the present invention will become more apparent by the detailed description in conjunction with the accompanying drawings.

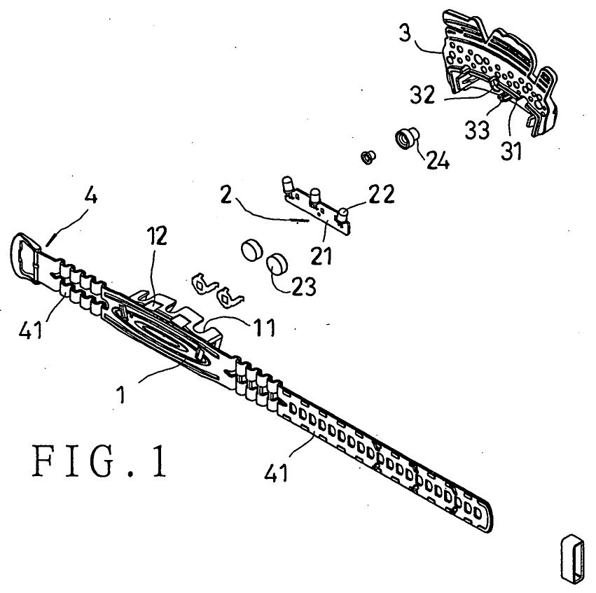

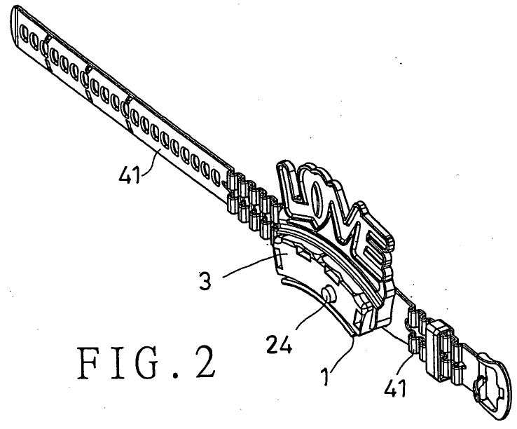

Firstly referring to FIG. 1 and 2, in which the carry-on light emitting decoration of the present invention is shown to comprise mainly a base (1), a light emitting device (2), an ornament section (3) and a wearing member (4).

The base (1) is provided with a receiving section (11) for accommodating a light emitting device (2). An engagement section (12) in the shape of a hook groove herein is provided on the peripheral wall of the base (1) for interlocking with an engagement section (31) in the shape of a hook retainer herein provided on the ornament section (3).

The light emitting device (2) is provided within the receiving section (11), which has a circuit board (21) connected to the light emitting body (22), such as LEDs or light bulbs, a battery unit (23) and a button switch (24).

The ornament section (3) is provided with an engagement section (31) in the shape of a hook retainer herein for interlocking with an engagement section (12) in the shape of a hook groove herein provided on the peripheral wall of the base (1). A through hole (32) corresponding to the button switch (24) of the light emitting device (2) is provided on the ornament section (3) for the penetration out of the button switch (24). A stop block (33) corresponding to the receiving section (11) of the base (1) is also provided on the ornament section (3) for abutting and positioning the light emitting device (2) provided within the receiving section (11) of the base (1). The ornament section (3) has, for example, the design of “TAIWAN”, “LOVE” which matches with specific event theme.

Referring to FIG. 1, 3, 5, 7, the wearing member (4) is fixed on the base (1), which can be a watch band (41), a hair hoop (42), an arm ring (43) or a hat hoop (44). The fixation between the wearing member (4) and the base (1) will be explained as follow.

The watch band (41) is integrally formed with the base (1) and is connected on both sides of the base (1), as shown in FIGS. 1 and 2.

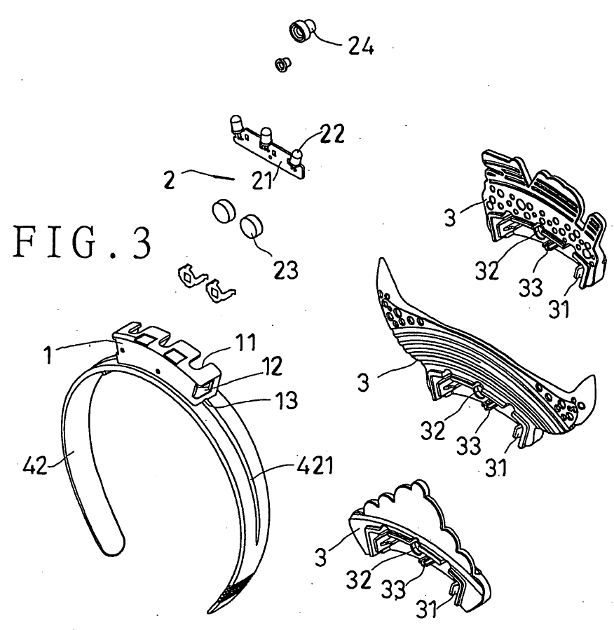

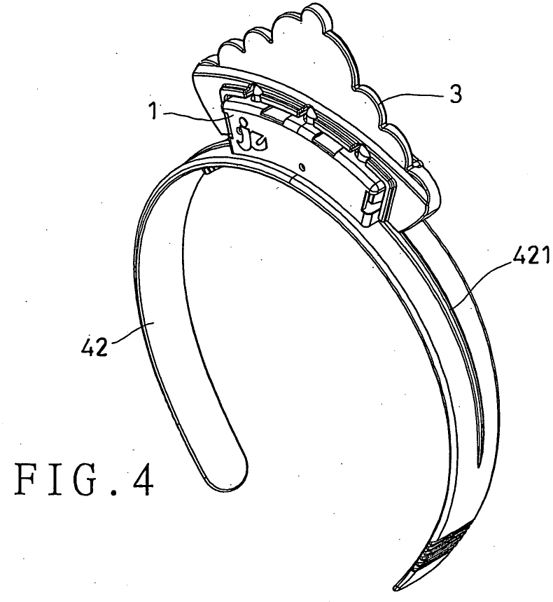

The hair hoop (42) is formed with a peripheral projection (421) at the upper face, which is engaged with a slot (13) provided on the bottom of the base (1), as shown in FIGS. 3 and 4.

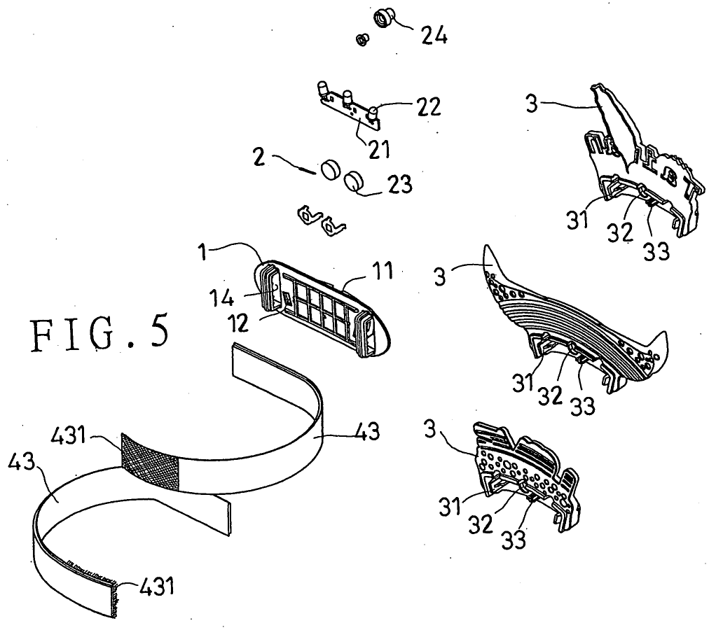

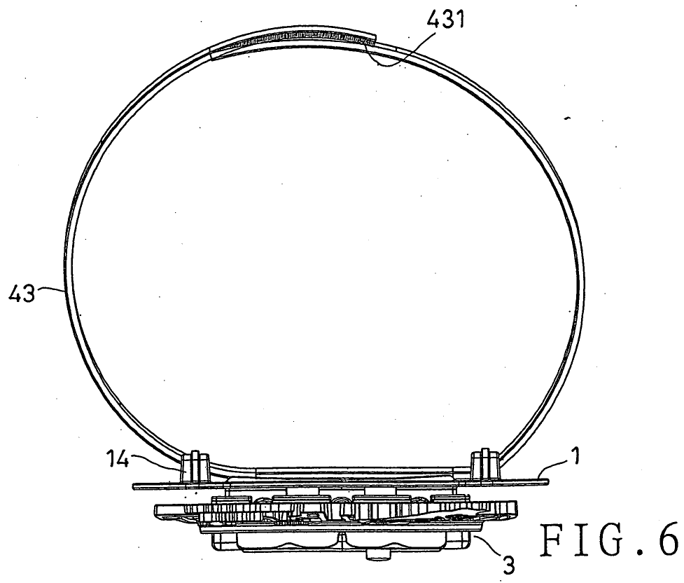

The arm ring (43) is a strap which is provided with fastener tapes (431) on both ends. A retaining ring (14) is provided on the bottom of the base (1) for the penetration of the arm ring (43), as shown in FIGS. 5 and 6.

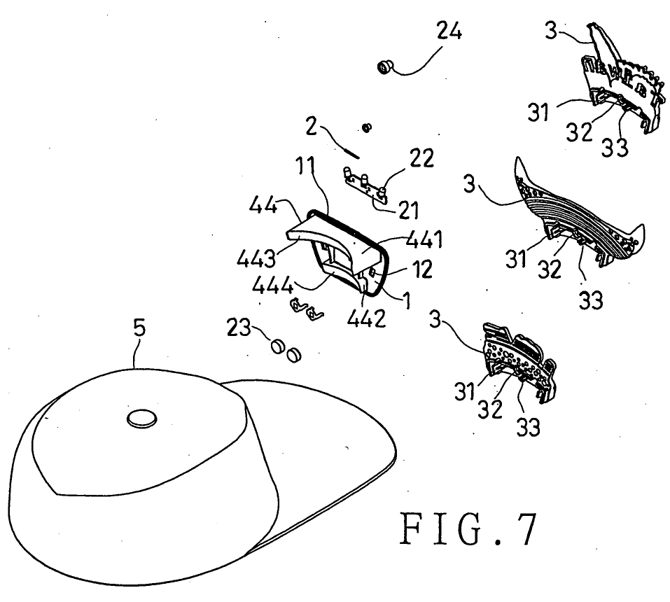

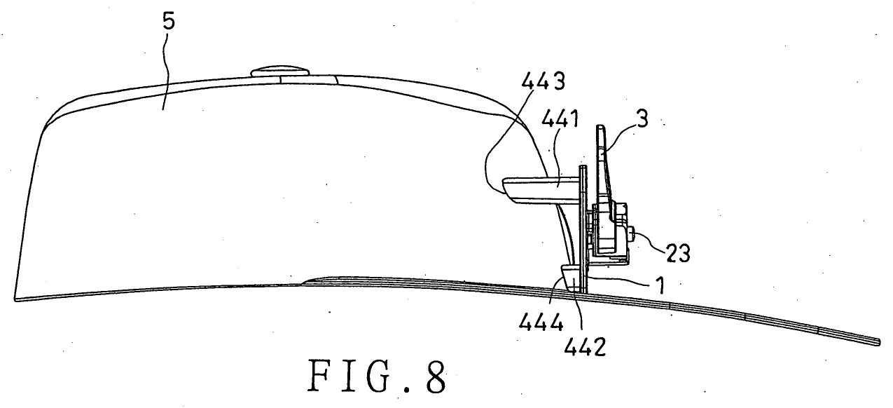

The hat hoop (44) has upper and lower positioning pieces (441), (442) projected from and integrally formed on the rear face of the base (1). The upper and lower positioning pieces (441), (442) have respectively the cambered faces (443), (444) the curvatures of which are in conformity with the curvatures of a hat body (5) so as to be fixed on the hat body (5), as shown in FIGS. 7 and 8.

In assembly process, the light emitting device (2) is disposed within the receiving section (11) of the base (1) as shown in FIGS. 1 and 2, and then the ornament section (3) is correspondingly fixed on the base (1) such that the engagement section (31) in the shape of a hook retainer herein of the ornament section (3) is interlocked with the engagement section (12) in the shape of a hook groove herein of the base (1). In the mean time, the stop block (33) of the ornament section (3) abuts and positions the light emitting device (2) provided within the receiving section (11) of the base (1) in such a manner that the button switch (24) of the light emitting device (2) penetrates out of the through hole (32) of the ornament section (3). Then, the carry-on light emitting device (2) of the present invention is worn on user's hand, head, and arm or fixed on the hat body.

According to this structure, when the carry-on light emitting decoration is hung on a user's body, the event theme is highlighted by the appearance design provided on the ornament section so as to raise the advertisement effect of event. Furthermore, the button switch (24) is pushed down to trigger the emitting of light from the light emitting body of the light emitting device (2) at night activity so as to enhance strange and cool feeling and to construct the bustling atmosphere making effects of the activities.

Based on the above structure and embodiments, this invention surely has the following advantages when comparing with prior art.

(1) The carry-on light emitting decoration can be worn on a user's hand, head, and arm or fixed on hat body. The design, for example, of “TAIWAN” or “LOVE” presented on the ornament section enables the present invention become a contemporary ornament item when it is worn on the user's body. Moreover, when the carry-on light emitting decoration is used accompanying with the proceeding of business promotion or literature and art presentation activity, the bustling atmosphere making effect of the activity can be further raised.

(2) A light emitting device is provided in the present invention. The light emitted from the light emitting device and transmitted through the ornament section enables the enhancement of bustling atmosphere making effect of night activity.

Summing up above, the embodiment of this invention can reach expected effectiveness, and the specific configurations disclosed herein have yet not seen in the prior art of the same category of product, even has not been opened to the public before application.

Additional advantages and modifications will readily occur to those skilled in the art. Therefore, this invention in its broader aspects is not limited to the specific details and representative embodiment shown and described herein. Accordingly, various modifications and variations may be made without departing from the spirit and scope of the general inventive concept as defined by the appended claims and their equivalents.

What is claimed is:

1. A carry-on light emitting decoration, comprising:
a base provided with a receiving section for accommodating a light emitting device; the peripheral wall of said base is provided with an engagement section for interlocking with a corresponding engagement section provided on the ornament section;
a light emitting device provided within said receiving section, which has a circuit board connected to the light emitting bodies, a battery unit and a button switch;
an ornament section provided with an engagement section for interlocking with a corresponding engagement section provided on the peripheral wall of the base, a through hole corresponding to the button switch of said light emitting device is provided on the ornament section for the penetration out of the button switch, and said ornament section is provided with an appearance design;
a wearing member fixed on said base.

2. A carry-on light emitting decoration as claimed in claim 1, wherein said wearing member is a watch band integrally formed with the base and connected on both sides of said base.

3. A carry-on light emitting decoration as claimed in claim 1, wherein said wearing member is a hair hoop formed with a peripheral projection at the upper face, which is engaged with a slot provided on the bottom of said base.

4. A carry-on light emitting decoration as claimed in claim 1, wherein said wearing member is an arm ring of a strap body, fastener tapes being provided on both ends of said strap, a retaining ring being provided on the bottom of said base for the penetration and combination of the arm ring.

5. A carry-on light emitting decoration as claimed in claim 1, wherein said wearing member is a hat hoop having upper and lower positioning pieces projected from and integrally formed on the rear face of said base, cambered faces having curvatures in conformity with the curvatures of the hat body being provided respectively on said upper and lower positioning pieces.

6. A carry-on light emitting decoration as claimed in claim 1, wherein said engagement section provided on the peripheral wall of said base is a hook groove, while said engagement section provided on ornament section is a hook retainer corresponding to said hook groove.

7. A carry-on light emitting decoration as claimed in claim 1, wherein said ornament section is provided with a stop block corresponding to the receiving section of said base for abutting and positioning said light emitting device provided within the receiving section of said base.

8. A carry-on light emitting decoration as claimed in claim 1, wherein said light emitting body is a light emitting diode.
